(19) United States
(12) Patent Application Publication
(10) Pub. No.: US 2016/0328110 A1
(43) Pub. Date: Nov. 10, 2016

(54) METHOD, SYSTEM, EQUIPMENT AND DEVICE FOR IDENTIFYING IMAGE BASED ON IMAGE

(71) Applicant: BEIJING QIHOO TECHNOLOGY COMPANY LIMITED, Beijing (CN)

(72) Inventors: Jin ZHAO, Beijing (CN); Yiguo CHEN, Beijing (CN); Jinhui HU, Beijing (CN); Yugang HAN, Beijing (CN)

(21) Appl. No.: 15/109,432

(22) PCT Filed: Sep. 30, 2014
(86) PCT No.: PCT/CN2014/087992

§ 371 Date: Jun. 30, 2016

(30) Foreign Application Priority Data
Dec. 30, 2013 (CN) 201310744455.X
Dec. 30, 2013 (CN) 201310745246.7
Dec. 30, 2013 (CN) 201310745678.8

(51) Int. Cl. G06F 3/0486; G06F 3/0484; G06F 17/30; G06T 1/00

(52) U.S. Cl. CPC G06F 3/0486; G06T 1/0007; G06F 3/04845; G06F 17/30864; G06F 17/3028; G06T 2200/24

(57) ABSTRACT

Disclosed are an image-based image identification method, system, equipment and device, the method comprising: extracting to-be-identified image information inputted by a user in an image identification field; transmitting a request carrying the to-be-identified image information to an image engine server; and receiving and displaying related information of other image resources matching the to-be-identified image information returned by the image engine server. In an embodiment of the present invention, the request is transmitted to an image engine server according to the obtained to-be-identified image information, and, according to the to-be-identified image information, the image engine server searches for the related information of other image resources matching the to-be-identified image information, thus realizing image identification based on image information, enlarging the application range of image identification, and facilitating use.

### CROSS-REFERENCE TO RELATED APPLICATIONS

This application is the national stage of International Application No. PCT/CN2014/087992 filed Sep. 30, 2014, which is based upon and claims priority to Chinese Patent Applications No. CN201310745246.7, CN201310744455.X, and CN201310745678.8, all of which are filed Dec. 30, 2013, the entire contents of which are incorporated herein by reference.

### FIELD OF TECHNOLOGY

The disclosure relates to the field of image identification technologies, and more particularly, to a method, system, equipment and device for identifying an image based on an image.

### BACKGROUND

Image search refers to a service for providing relevant image information on the Internet for a user by means of a search program. An objective of image search is to enable the user to search out a particular image required for the user.

In the prior art, when a user conducts an image search, the user inputs a description text of an image into a search box so that a server makes an image search according to the description text of the image.

In the prior art, when a user conducts an image search, after opening a browser, the user clicks Type “Image” above a search box, inputs a description text-such as “Liu Dehua”—of an image into the search box, and clicks a search button on the right to send a corresponding request to a server so that the server returns image information searched out to the user according to the received request.

The image search method in the prior art is only applicable to searching based on a description text of an image. If the user has acquired a certain image and needs to identify information related to the image, for example, attribute information of an original image of the image, no corresponding scheme is provided in the prior art. Therefore, how to acquire information related to a known image according to the image becomes a problem to be solved urgently.

### SUMMARY

In the view of above problems, the disclosure is proposed to provide a method, system, equipment and device for identifying an image based on image information to overcome the above problem or at least partially solve or alleviate the above problem, a method, system, equipment and device for identifying an image based on dragging an image to overcome the above problem or at least partially solve or alleviate the above problem, and a method, system, equipment and device for identifying an image based on screenshot information to overcome the above problem or at least partially solve or alleviate the above problem.

According to an aspect of the disclosure, there is provided a method for identifying an image based on image information, comprising: extracting to-be-identified image information inputted by a user into an image identification box; sending a request carrying the to-be-identified image information to an image engine server; receiving other image resource-related information matching with the to-be-identified image information searched out by the image engine server; and displaying an image identification result of the to-be-identified image constructed according to the other image resource-related information.

According to another aspect of the disclosure, there is provided a device for identifying an image based on image information, comprising: an extracting module, configured to extract to-be-identified image information inputted by a user into an image identification box; a sending module, configured to send a request carrying the to-be-identified image information to an image engine server; and a receiving and displaying module, configured to receive other image resource-related information matching with the to-be-identified image information searched out by the image engine server, and display an image identification result of the to-be-identified image constructed according to the other image resource-related information.

According to still another aspect of the disclosure, there is provided terminal equipment including the above device.

According to still another aspect of the disclosure, there is provided a system for identifying an image based on image information, including the device above and an engine server configured to receive a request carrying the to-be-identified image information, search out and provide other image resource-related information matching with the to-be-identified image information.

According to still another aspect of the disclosure, there is provided a computer program, comprising a computer-readable code, wherein when the computer-readable code runs on a terminal equipment, the terminal equipment executes the method for identifying an image based on image information.

According to still another aspect of the disclosure, there is provided a computer-readable medium, storing the computer program above.

According to an aspect of the disclosure, there is provided a method for identifying an image based on dragging an image, comprising: identifying a user's dragging operation in a set area, and providing a dragging placement input box for the user; extracting data information inputted by the user into the dragging placement input box; sending a request carrying the data information to an image engine server; and receiving and displaying image resource-related information matching with the data information searched out by the image engine server.

According to another aspect of the disclosure, there is provided a device for identifying an image based on dragging an image, comprising: an identifying and providing module, configured to identify a user's dragging operation in a set area, and provide a dragging placement input box for the user; an extracting module, configured to extract data information inputted by the user into the dragging placement input box; sending module, configured to send a request carrying the data information to an image engine server; and a receiving and displaying module, configured to receive and display image resource-related information matching with the data information searched out by the image engine server.

According to still another aspect of the disclosure, there is provided terminal equipment including the above device.

According to still another aspect of the disclosure, there is provided a system for identifying an image based on dragging an image, including the device above and an engine server configured to receive a request carrying the data information, search out and provide other image resource-related information matching with the data information.

According to still another aspect of the disclosure, there is provided a computer program, comprising a computer-readable code, wherein when the computer-readable code runs on a terminal equipment, the terminal equipment executes the method for identifying an image based on dragging an image.

According to still another aspect of the disclosure, there is provided a computer-readable medium, storing the computer program above.

According to an aspect of the disclosure, there is provided a method for identifying an image based on screenshot information, comprising: identifying a paste event triggered by a user in an image identification box; acquiring data information corresponding to the paste event, and determining whether the data information corresponding to the paste event is image information or not; sending a request carrying the image information to an image engine server when the data information corresponding to the paste event is image information; and receiving and displaying other image resource-related information matching with the image information searched out by the image engine server.

According to another aspect of the disclosure, there is provided a device for identifying an image based on screenshot information, comprising: an identifying module, configured to identify a paste event triggered by a user in an image identification box; an acquiring and determining module, configured to acquire data information corresponding to the paste event, and determine whether the data information corresponding to the paste event is image information or not; a sending module, configured to send a request carrying the image information to an image engine server when the data information corresponding to the paste event is determined by the acquiring and determining module to be image information; and a receiving and displaying module, configured to receive and display other image resource-related information matching with the image information searched out by the image engine server.

According to another aspect of the disclosure, there is provided terminal equipment including the above device.

According to still another aspect of the disclosure, there is provided a system for identifying an image based on screenshot information, including the device above and an engine server configured to search out other image resource-related information matching with the image information according to the request and send the other image resource-related information to the device.

According to still another aspect of the disclosure, there is provided a computer program, comprising a computer-readable code, wherein when the computer-readable code runs on terminal equipment, the terminal equipment executes the method for identifying an image based on screenshot information.

According to still another aspect of the disclosure, there is provided a computer-readable medium, storing the computer program above.

The disclosure has following beneficial effects.

Embodiments of the disclosure provide a method, system, equipment and device for identifying an image based on image information. The method includes: extracting to-be-identified image information inputted by a user into an image identification box; sending a request carrying the to-be-identified image information to an image engine server; and receiving and displaying other image resource-related information matching with the to-be-identified image information returned by the image engine server. In the embodiments of the disclosure, a request is sent to the image engine server according to acquired to-be-identified image information, and an image index server searches, according to the to-be-identified image information, other image resource-related information matching with the to-be-identified image information, thereby implementing the method for identifying an image based on image information, broadening an application scope of image identification, and facilitating use for the user.

Embodiments of the disclosure provide a method, system, equipment and device for identifying an image based on dragging an image. The method includes: identifying a user's dragging operation in a set area, and providing a dragging placement input box; extracting data information inputted by the user into the dragging placement input box, and sending the data information to an image engine server; and receiving and displaying image resource-related information matching with the data information returned by the image engine server. In the embodiments of the disclosure, image resource-related information matching with data information corresponding to a dragging operation is provided for the user based on the user's dragging operation, thereby implementing the method for identifying an image based on image information, broadening an application scope of image identification, and facilitating use for the user.

Embodiments of the disclosure provide a method, system, equipment and device for identifying an image based on screenshot information. The method includes: identifying a paste event triggered by a user in an image identification box; when data information corresponding to the paste event is determined to be image information, sending a request carrying the image information corresponding to the paste event to an image engine server; and receiving and displaying other image resource-related information matching with the image information searched out by the image engine server. In the embodiments of the disclosure, image resource-related information matching with the screenshot information is provided for the user based on the copied screenshot information, thereby implementing the method for identifying an image based on image information, broadening an application scope of image identification, and facilitating use for the user.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to a person having ordinary skill in the art. Accompanying drawings are merely included for the purpose of illustrating the preferred embodiments and should not be considered as limiting of the invention. Further, throughout the drawings, same elements are indicated by same reference numbers. In the drawings:

FIG. 1 shows a process of identifying an image based on image information according to an embodiment of the disclosure;

FIG. 2 is a schematic structural diagram of a device for identifying an image based on image information according to an embodiment of the disclosure;

FIG. 3 is a schematic structural diagram of terminal equipment according to an embodiment of the disclosure;

FIG. 4 is a schematic structural diagram of a system for identifying an image based on image information according to an embodiment of the disclosure;

FIG. 5 is a process of identifying an image based on dragging an image according to an embodiment of the disclosure;

FIG. 6 is a process of identifying an image based on locally dragging an image according to an embodiment of the disclosure;

FIG. 7 is a schematic structural diagram of a device for identifying an image based on dragging an image according to an embodiment of the disclosure;

FIG. 8 is a schematic structural diagram of terminal equipment according to an embodiment of the disclosure;

FIG. 9 is a schematic structural diagram of a system for identifying an image based on dragging an image according to an embodiment of the disclosure;

FIG. 10 is a schematic diagram of a process of identifying an image based on screenshot information according to an embodiment of the disclosure;

FIG. 11 is a schematic structural diagram of a device for identifying an image based on screenshot information according to an embodiment of the disclosure;

FIG. 12 is a schematic structural diagram of a system for identifying an image based on screenshot information according to an embodiment of the disclosure;

FIG. 13 is a schematic structural diagram of terminal equipment according to an embodiment of the disclosure;

FIG. 14 schematically shows a block diagram of a computing device for executing the method according to the disclosure; and

FIG. 15 schematically shows a storage unit for maintaining or carrying a program code for implementing the method according to the disclosure.

### DESCRIPTION OF THE EMBODIMENTS

To implement a scheme for identifying an image based on image information, broaden an application scope of image identification and facilitate use for a user, embodiments of the disclosure provide a method, system, equipment and device for identifying an image based on an image.

Exemplary embodiments of the disclosure will be described in detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

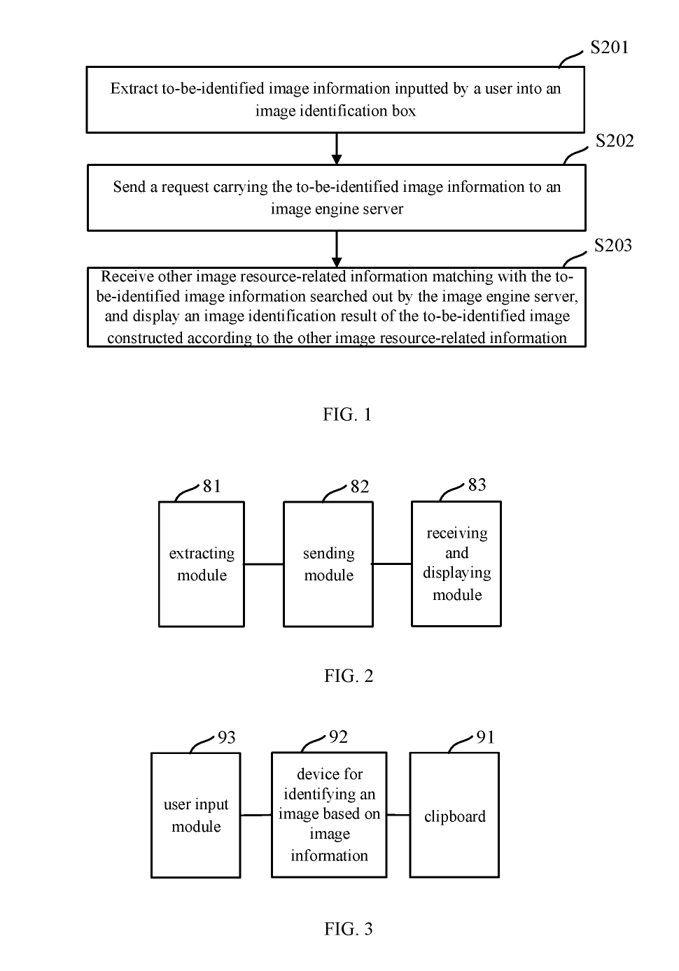

FIG. 1 shows a process of identifying an image based on image information according to an embodiment of the disclosure, and the process includes following steps:

S201: Extract to-be-identified image information inputted by a user into an image identification box.

The to-be-identified image information includes: image description information, image information or image link address information, etc. The image description information includes a text for describing an image feature, for example, “Liu Dehua”, “scenery” or “beauty”, etc.

When the identification method based on an image provided by embodiments of the disclosure is used for image identification, not only an image may be identified based on to-be-identified image information such as image information or image link address information, but also corresponding relevant images may be identified according to image description information. In addition, no matter the user inputs the image description information, the image information or the image link address information, all the information should be inputted into the same image identification box.

S202: Send a request carrying the to-be-identified image information to an image engine server.

After it is received the request carrying the to-be-identified image information sent by the user, the request is sent to the image engine server, and other image resource-related information matching with the to-be-identified image information is provided for the user by means of the image engine server.

S203: Receive other image resource-related information matching with the to-be-identified image information searched out by the image engine server, and display an image identification result of the to-be-identified image constructed according to the other image resource-related information.

In the embodiments of the disclosure, a request is sent to the image engine server according to acquired to-be-identified image information, and an image index server searches, according to the to-be-identified image information, other image resource-related information matching with the to-be-identified image information, thereby implementing the method for identifying an image based on image information, broadening an application scope of image identification, and facilitating use for the user.

In the embodiments of the disclosure, an image-based identifying device positioned in user's local equipment is a client. When the user turns on the client, an image identification box appears on the client, and the client provides an interface for interacting with a user input module in the user's local equipment to acquire to-be-identified image information inputted by the user. The image identification box is configured to receive the to-be-identified image information inputted by the user, and the client extracts the to-be-identified image information inputted by the user into the image identification box, where the to-be-identified image information includes image description information, image information or image link address information, etc.

In the embodiments of the disclosure, the image identification box includes a search box and a dragging placement input box. The client provides different image identification boxes for the user in different input conditions. After being turned on, the client provides the search box. The client provides the dragging placement input box for the user when the client identifies the user's dragging start event in a set area.

### Embodiment I

During image identification based on image description information, the search box provided by the client receives image description information “Scenic Sketches” inputted by the user, the client extracts the image description information “Scenic Sketches” inputted by the user into the search box, and when the user clicks “Search”, the client receives a request carrying the image description information. The client identifies that what is carried in the request is a character string and determines that what is acquired is the image description information. The client wraps the request according to a data transfer format predetermined between the client and the image engine server, and sends the request to the image engine server.

The image engine server searches image-related information matching with the image description information according to the request carrying image description information provided by the client, and provides the image-related information to the client. The client receives the image-related information provided by the image engine server, and displays the image-related information to the user so as to identify the image-related information according to to-be-identified image information.

### Embodiment II

Image link address information inputted by the user is received by the search box provided by the client. The image link address information may be inputted by the user by means of a keyboard, or may be copied from certain image link address information. When it is copied from image link address information, the client identifies a paste event triggered by the user in the search box, for example, a “Ctrl+V” operation performed in the search box, or a “Copy” operation clicked in the search box. A clipboard of the user's local equipment is accessed through the interface to acquire the image link address information in the clipboard and display the image link address information in the search box.

The client extracts information inputted by the user into the search box, determines whether the information carries a link address identification field or not, and determines the information to be the image link address information when the information carries the link address identification field, where the link address identification field may be an “http” identification field. It is received the request carrying the image link address information sent by the user, the request is wrapped according to a data format predetermined between the client and the image engine server, and the wrapped request is sent to the image engine server. After receiving the request, the image engine server searches, according to the image link address information carried in the request, image resource-related information matching with the image link address information, and provides the image resource-related information to the client for display.

### Embodiment III

To-be-identified image information inputted by the user into the search box may be screenshot information, specifically, the extracting to-be-identified image information inputted by a user into an image identification box includes:

identifying a paste event triggered by the user in the search box;

accessing a clipboard of the user's local equipment according to the paste event; and

acquiring screenshot information in the clipboard, and taking the screenshot information as the extracted to-be-identified image information inputted by the user into the search box.

The identifying a paste event triggered by the user in the search box specifically includes identifying a “Ctrl+V” operation triggered in the search box, or identifying a “Copy” operation triggered in the search box, etc.

During image identification based on screenshot information, in the embodiments of the disclosure, when the client is turned on, the client provides the user with the search box for inputting the screenshot information.

To identify the user's operation in the search box, in the embodiments of the disclosure, a listening event is bound in the client, where in the listening event, information on operation of a mouse and a keyboard and location where the operation occurs are listened. Specifically, information such as whether each button of the mouse is pressed, which buttons of the keyboard are pressed and pressed at what time and what location or the like is recorded in a user input module of an operating system of the user's local equipment. A left mouse button being pressed and a right mouse button being pressed respectively correspond to a binary number. In the listening event, it is determined whether the current right mouse button is pressed or not by listening a corresponding binary number in the user input module of the operating system of the user's local equipment. When the location where the operation of the right mouse button being pressed occurs is positioned in the search box, a menu available for selection is provided for the user. When it is identified that the user selects a paste operation, it is determined that the user triggering a paste event in the search box is identified.

In addition, an operation of each button in the keyboard being pressed and the location where the operation occurs are recorded in the user input module of the operating system of the user's local equipment. It is determined that the user triggering a paste event in the search box is identified when the listening event listens an operation of both Ctrl key and V key on the keyboard being simultaneously pressed and the location where the operation occurs is positioned in the search box.

Before the user triggers the paste event in the search box, a screenshot operation is performed on a locally-saved image or an image on the Internet, and screenshot information corresponding to the screenshot operation is saved in the clipboard of the user's local equipment. When it is identified the paste event triggered by the user in the image identification box, it is accessed the clipboard of the user's local equipment, and it is acquired the data information corresponding to the paste event in the clipboard.

After the client acquires the data information corresponding to the paste event in the clipboard, it is determined whether the data information is image information. Specifically, it is determined whether a format of the data information corresponding to the paste event meets the format of the image information. For example, it is determined whether the format of the data information is an image format such as a .Jpg format or a .png format, etc. The data information is determined to be the to-be-identified image information when the format of the data information is an image format.

The process of acquiring screenshot information from the user's local equipment is similar to that of uploading screenshot information. Based on network connection status between the client and the user's local equipment, to facilitate the user to timely know about the process of uploading screenshot information, prompt information “Uploading the file” is displayed, and a prompt box where the prompt information is may substitute or overlay the image identification box.

When it is identified that the format of the information carried in the request is an image format, the client converts the screenshot information to a base64 format, and sends a request carrying the converted screenshot information to the image engine server.

The image engine server receives the request, and acquires other image resource-related information matching with the screenshot information according to the screenshot information carried in the request and to established index information. Specifically, the image index server establishes a characteristic index database according to browsed images, and after receiving the screenshot information, the image index server extracts characteristics such as colors, shapes and textures of the images, matches the images with images in the characteristic index database according to a certain rule, and takes images succeeded in matching as an identification result to be provided for the client.

When the identification result is acquired according to the screenshot information and a paste event triggered in the search box is received by the client, the clipboard of the user's local equipment is accessed to acquire screenshot information in the clipboard, and the acquired screenshot information, for example an image of an apple, is displayed in the search box. After the screenshot information is acquired from the clipboard of the user's local equipment and displayed, the client sends a request carrying the screenshot information to the image engine server. The image engine server acquires, according to the screenshot information carried in the request, other image resource-related information matching with the screenshot information, and provides the image resource-related information to the client for display. According to an image identification result constructed according to the screenshot information, the client not only displays the image of an apple in the search box of the image identification result, but also displays and processes the word “apple” matching with the image. Under the search box there is displayed other image resource-related information matching with the screenshot information—the image of an apple and the word “apple”, for example, a best guess at the screenshot information and apple-related images. Of course, to provide comprehensive information for the user, the image identification result may further include webpages containing the screenshot information, etc.

### Embodiment IV

Specifically, in the embodiments of the disclosure, when a client for identifying an image based on dragging an image is turned on, a desktop area occupied by the client is a set area. When the client occupies the whole desktop, the set area is the whole desktop area; and when the client occupies a part area of the desktop, the set area is a part area of the desktop occupied by the client. That is, the set area varies in size with the area occupied by the client when the client is turned on.

In addition, the dragging operation is an operation of dragging an image, where the image may be an image stored in the user's local equipment or may be an image displayed on a webpage on the Internet and so on.

To inform the user of a location for placing the data information corresponding to the dragging operation, the dragging placement input box may provide prompt information “Dragging the image here”.

An image in the dragging operation may be from the user's local equipment or from the Internet. Different sources of the image in the dragging operation may cause different types of data information corresponding to the dragging operation. Therefore, in the embodiments of the disclosure, the source of data information may be determined by identifying the type of the data information corresponding to the user's dragging operation, so that a corresponding manner is employed to extract the data information inputted by the user into the dragging placement input box.

During image identification based on dragging an image, in the embodiments of the disclosure, when a client is turned on, the client provides a user with a search box for inputting image information. When the client identifies the user's dragging operation in a set area, the search box is replaced with the dragging placement input box, the dragging placement input box is provided for the user, and the dragging placement input box may be employed to replace an interface behind the search box. To facilitate the user to dragging, the client may display prompt information “Dragging the image here” in the dragging placement input box to prompt the user a location for placing data information corresponding to an dragging operation

In the embodiments of the disclosure, the identifying the user's dragging start event in a set area includes:

when it is monitored an operation of holding down and moving the left mouse button in the set area, taking the operation as the user's dragging start event in the set area.

To identify the user's dragging operation in the set area, in the embodiments of the disclosure, a listening event is bound in the client, where in the listening event, information on operation of the mouse and location where the operation occurs are listened. Specifically, information such as whether each button of the mouse is pressed, and is pressed at what time and at what location, and whether the mouse is moved, and is moved at what time and to what location is recorded in the user input module of the operating system of the user's local equipment. The left mouse button being pressed and the right mouse button being pressed respectively correspond to a binary number. In the listening event, it is determined whether the current left mouse button is pressed or not and whether the left mouse button is moved while it is held down by listening a corresponding binary number in the user input module of the operating system of the user's local equipment. It is determined whether the user's current operation is a dragging operation.

In the listening event, it is determined whether the dragging operation enters the set area according to a dragging location of the dragging operation and the predefined set area. When the dragging operation enters the set area, the client provides the user with a dragging placement input box. That is, a dragging placement input box for receiving the dragging information is provided for the user when it is identified the user's dragging start event in the set area.

The dragging start event is a dragging start event specific to the set area, and a dragging operation corresponding to the dragging start event may likely have already been started for a period of time. For example, when the user drags a local file into the search box provided by the client, the dragging operation has already gotten under way, but the dragging operation is out of the set area in the beginning, and the dragging operation is not taken as the dragging start event in the set area until the dragging operation enters within the set area. The dragging placement input box for receiving the dragging information is provided for the user when the client identifies the user's dragging start event in the set area.

In the embodiments of the disclosure, a dragging operation may be specific to a local file or may be specific to network resource. Different sources of data information of the dragging operation may cause different types of the data information corresponding to the dragging operation. Therefore, the extracting data information inputted by the user into the dragging placement input box includes:

identifying a type of data information corresponding to the user's dragging operation; and

when the type of the data information is determined to be a local file, providing address information for the user's local equipment for uploading an image, accessing the address, acquiring image information corresponding to the dragging operation, and taking the image information as the extracted data information inputted by the user into the dragging placement input box.

Some images are saved on the user's local equipment. These images may be downloaded from the Internet or may be obtained by the user by photographing. In the embodiments of the disclosure, an identification may be performed on the images saved on the user's local equipment. Specifically, the user may dragging the images saved on the user's local equipment into the dragging placement input box provided by the client. When the client identifies a dragging start event in the set area, the client provides address information for the user's local equipment for uploading an image according to the type of data information corresponding to the dragging operation, so that the user uploads the image to the address. After the user's local equipment uploads the image to the address, the client accesses the address to acquire image information corresponding to the dragging operation. In the process of uploading the image, to facilitate the user to timely know about the process of uploading the image, prompt information “Uploading the file” may be displayed in the dragging placement input box.

In the embodiments of the disclosure, the sending the request carrying the data information to the image engine server includes:

identifying a dragging end event triggered by the user in the dragging placement input box; and

sending the request carrying the data information to the image engine server.

Specifically, the identifying a dragging end event triggered by the user in the dragging placement input box includes:

when it is monitored an operation of releasing the left mouse button in the dragging placement input box, taking the operation as the dragging end event triggered by the user in the dragging placement input box.

According to the above description, in the embodiments of the disclosure, the dragging end event triggered by the user in the dragging placement input box is also monitored by means of a listening event. Specifically, the dragging end event is acquired by monitoring the user input module in the user's local equipment. Since at the moment the location of the client is known, the location of the dragging placement input box is also known. It is determined whether the dragging end event is identified or not by monitoring whether the user triggers an operation of releasing the left mouse button in the dragging placement input box or not.

It is determined that the dragging end event triggered by the user in the dragging placement input box is identified when it is identified the operation of releasing the left mouse button in the dragging placement input box. The extracted data information in the dragging placement input box is carried in a request, and the request is sent to the image engine server.

The foregoing embodiment shows a process of identifying dragging an image from the user's local equipment and identifying the image. When the type of data information is determined to be network resource according to the type of the data information corresponding to the dragging operation, the extracting data information inputted by the user into the dragging placement input box includes: identifying the type of data information corresponding to the user's dragging operation; and when the type of the data information is determined to be network resource, acquiring a resource link address corresponding to the image information; and when the data information corresponding to the resource link address is determined to be image information, taking the resource link address as the extracted data information inputted by the user into the dragging placement input box.

When an image is dragged from the Internet, the data information corresponding to the dragging operation is a link address. Therefore, the source of the data information corresponding to the dragging operation may be determined according to the type of the data information. When the type of the data information is determined to be network resource, it is determined whether the data information corresponding to the resource link address is image information or not. When the data information corresponding to the resource link address is image information, the resource link address is taken as the extracted data information inputted by the user into the dragging placement input box.

When it is determined whether the data information corresponding to the resource link address is image information or not, the data information corresponding to the resource link address may be directly accessed to determine whether the format of the data information is the format of the image information so as to determine whether the data information is the image information or not. Alternatively, it is directly determined whether a suffix of the resource link address is a suffix of an image format, for example, it is determined whether the suffix of the resource link address is .jpg or .png or the like. It is determined that the data information corresponding to the resource link address is image information when the suffix of the resource link address is the suffix of an image format.

When network resource is dragged, for example, a link address of an image to be dragged is http://i2.3conline.com/images/piclib/201112/07/batch/1/119940/1323247381299u10eyma616.jpg, the client identifies the dragging start event in the set area, replaces the search box with the dragging placement input box, and displays prompt information “Dragging the image here” in the dragging placement input box. When the client determines that the type of the data information corresponding to the dragging operation is the resource link address after the data information is dragged into the dragging placement input box, it is determined that the data information is from network resource, it is acquired the resource link address corresponding to the image information, it is determined that the suffix of the resource link address is .jpg, it is determined that the data information corresponding to the resource link address is image information, and the resource link address is taken as the extracted data information inputted by the user into the dragging placement input box.

When a dragging end event is identified in the dragging placement input box, a request carrying the resource link address is sent to the image engine server. The image engine server searches out and sends image resource-related information matching with the data information to the client, and the client displays an image identification result of the to-be-identified image constructed according to other image resource-related information. In the image identification result, what is displayed in the search box is an image corresponding to the link address http://i2.3conline.com/images/piclib/201112/07/batch/1/119940/1323247381299u10eyma616.jpg, the search box also displays a description text “Plants vs. Zombies” matching with the image, and below the search box there displays other image resource-related information matching with the image information. For example, below the search box there displays other image resource-related information matching with data information in the search box, for example, a best guess at the data information, or an image related to the data information. Of course, to provide comprehensive information for the user, the image identification result may further include webpages containing the data information, etc.

FIG. 2 is a schematic structural diagram of a device for identifying an image based on image information according to an embodiment of the disclosure, where the device includes:

an extracting module 81, configured to extract to-be-identified image information inputted by a user into an image identification box;

a sending module 82, configured to send a request carrying the to-be-identified image information to an image engine server; and

a receiving and displaying module 83, configured to receive other image resource-related information matching with the to-be-identified image information searched out by the image engine server, and display an image identification result of the to-be-identified image constructed according to the other image resource-related information.

The extracting module 81 is specifically configured to identify a paste event triggered by a user in a search box, access a clipboard of the user's local equipment according to the paste event, acquire screenshot information in the clipboard, and take the screenshot information as the extracted to-be-identified image information inputted by the user into the search box.

The device further includes:

a search box providing module 84, configured to provide the user with a dragging placement input box for receiving dragging information when it is identified the user's dragging start event in a set area.

The search box providing module 84 is specifically configured to take, when it is monitored an operation of holding down and moving a left mouse button in the set area, the operation as the user's dragging start event in the set area.

The sending module 82 is specifically configured to identify a dragging end event triggered by the user in the dragging placement input box, and send the request carrying the to-be-identified image information inputted into the dragging placement input box to the image engine server.

The search box providing module 84 is specifically configured to take, when it is monitored an operation of releasing the left mouse button in the dragging placement input box, the operation as the dragging end event triggered by the user in the dragging placement input box.

The extracting module 81 is specifically configured to identify a type of to-be-identified image information corresponding to the user's dragging operation, and when the to-be-identified image information is determined to be a local file, provide address information for the user's local equipment for uploading an image, access the address, acquire image information corresponding to the dragging operation, and take the image information as the extracted to-be-identified image information inputted by the user into the dragging placement input box.

The extracting module 81 is specifically configured to identify the type of to-be-identified image information corresponding to the user's dragging operation, acquire a resource link address corresponding to the image information when the to-be-identified image information is determined to be network resource, and take the resource link address as extracted to-be-identified image link address information inputted by the user into the dragging placement input box when data information corresponding to the resource link address is determined to be the image information.

The sending module 82 is specifically configured to convert, when the request carries image information, the image information to a base64 format, and send the request in which the converted image information is carried to the image engine server.

FIG. 3 is a schematic structural diagram of terminal equipment according to an embodiment of the disclosure, where the terminal equipment includes the device as shown in FIG. 2.

The terminal equipment further includes:

a clipboard 91, configured to store screenshot information corresponding to a copy event; and

the device 92, configured to identify a paste event triggered by a user in a search box, access the clipboard of the user's local equipment according to the paste event, acquire screenshot information in the clipboard, and take the screenshot information as extracted to-be-identified image information inputted by the user into the search box.

The terminal equipment further includes:

a user input module 93, configured to record the user's current operation on a mouse in a corresponding location; and

the device 92, specifically configured to take, when it is monitored the user's operation of holding down and moving a left mouse button recorded in the user input module, the operation as the user's dragging start event.

The device 92 is further configured to take, when it is monitored the user's operation of releasing the left mouse button in the dragging placement input box recorded in the user input module, the operation as the dragging end event triggered by the user in the dragging placement input box.

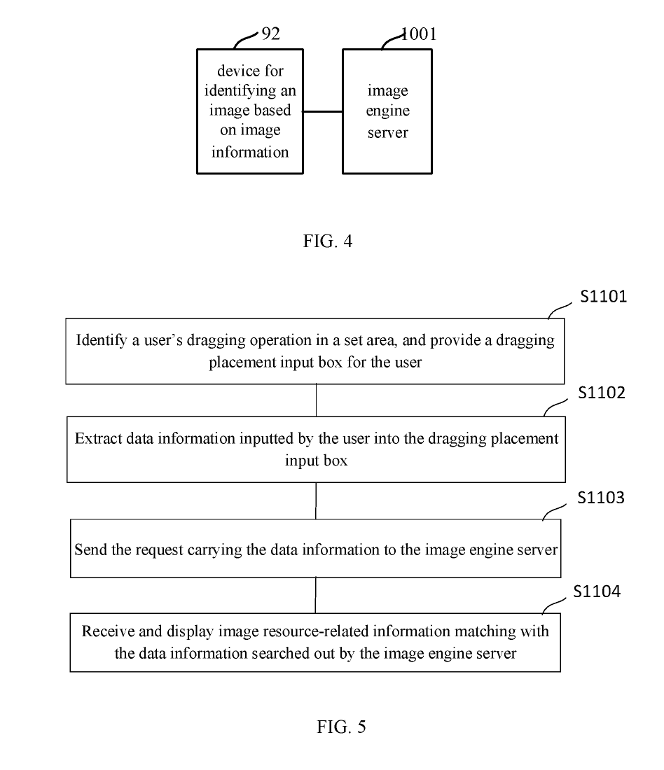

FIG. 4 is a schematic structural diagram of a system for identifying an image based on image information according to an embodiment of the disclosure, where the system includes the device 92 mentioned in FIG. 2, and an image engine server 1001 configured to receive a request carrying the to-be-identified image information, search out and provide other image resource-related information matching with the to-be-identified image information.

Embodiments of the disclosure provide a method, system, equipment and device for identifying an image based on image information. The method includes: extracting to-be-identified image information inputted by a user into an image identification box; sending a request carrying the to-be-identified image information to an image engine server; and receiving and displaying other image resource-related information matching with the to-be-identified image information returned by the image engine server. In the embodiments of the disclosure, a request is sent to the image engine server according to acquired to-be-identified image information, and an image index server searches, according to the to-be-identified image information, other image resource-related information matching with the to-be-identified image information, thereby implementing the method for identifying an image based on image information, broadening an application scope of image identification, and facilitating use for the user.

To implement a scheme for identifying an image based on image information, broaden an application scope of image identification and facilitate use for a user, The embodiments of the disclosure provide a method, system, equipment and device for identifying an image based on dragging an image.

In the following the embodiments of the disclosure are described with reference to the accompanying drawings.

FIG. 5 is a process of identifying an image based on dragging an image according to an embodiment of the disclosure, where the process includes following steps:

S1101: Identify a user's dragging operation in a set area, and provide a dragging placement input box for the user.

Specifically, in the embodiments of the disclosure, when a client for identifying an image based on dragging an image is turned on, a desktop area occupied by the client is the set area. When the client occupies the whole desktop, the set area is the whole desktop area; and when the client occupies a part area of the desktop, the set area is a part area of the desktop occupied by the client. That is, the set area varies in size with the area occupied by the client when the client is turned on.

In addition, the dragging operation is an operation of dragging an image, where the image may be an image stored in the user's local equipment or may be an image displayed on a webpage on the Internet and so on.

To inform the user of a location for placing the data information corresponding to the dragging operation, the dragging placement input box may provide prompt information “Dragging the image here”.

S1102: Extract data information inputted by the user into the dragging placement input box.

An image in a dragging operation may be from the user's local equipment or from the Internet. Different sources of the image in the dragging operation may cause different types of data information corresponding to the dragging operation. Therefore, in the embodiments of the disclosure, the source of data information may be determined by identifying the type of the data information corresponding to the user's dragging operation, so that a corresponding manner is employed to extract the data information inputted by the user into the dragging placement input box.

S1103: Send the request carrying the data information to the image engine server.

After it is received the request carrying the data information sent by the user, the request is sent to the image engine server, and other image resource-related information matching with the data information is provided for the user by means of the image engine server.

S1104: Receive and display image resource-related information matching with the data information searched out by the image engine server.

It is received other image resource-related information matching with the data information searched out by the image engine server, and an image identification result is constructed according to the other image resource-related information.

In the embodiments of the disclosure, image resource-related information matching with data information corresponding to a dragging operation is provided for the user based on the user's dragging operation, thereby implementing the method for identifying an image based on image information, broadening an application scope of image identification, and facilitating use for the user.

During image identification based on dragging an image, in the embodiments of the disclosure, when a client is turned on, the client provides a user with a search box for inputting image information. When the client identifies the user's dragging operation in a set area, the search box is replaced with the dragging placement input box, and the dragging placement input box is provided for the user. To facilitate the user to dragging, the client may display prompt information “Dragging the image here” in the dragging placement input box to prompt the user a location for placing data information corresponding to an dragging operation

In the embodiments of the disclosure, the identifying the user's dragging start event in a set area includes:

when it is monitored an operation of holding down and moving the left mouse button in the set area, taking the operation as the user's dragging start event in the set area.

To identify the user's dragging operation in the set area, in the embodiments of the disclosure, a listening event is bound in the client, where in the listening event, information on operation of the mouse and location where the operation occurs are listened. Specifically, information such as whether each button of the mouse is pressed, and is pressed at what time and at what location, and whether the mouse is moved, and is moved at what time and to what location is recorded in the user input module of the operating system of the user's local equipment. The left mouse button being pressed and the right mouse button being pressed respectively correspond to a binary number. In the listening event, it is determined whether the current left mouse button is pressed or not and whether the left mouse button is moved while it is held down by listening a corresponding binary number in the user input module of the operating system of the user's local equipment. It is determined whether the user's current operation is a dragging operation.

In the listening event, it is determined whether the dragging operation enters the set area according to a dragging location of the dragging operation and the predefined set area. When the dragging operation enters the set area, the client provides the user with a dragging placement input box. That is, a dragging placement input box for receiving the dragging information is provided for the user when it is identified the user's dragging start event in the set area.

The dragging start event is a dragging start event specific to the set area, and a dragging operation corresponding to the dragging start event may likely have already been started for a period of time. For example, when the user drags a local file into the search box provided by the client, the dragging operation has already gotten under way, but the dragging operation is out of the set area in the beginning, and the dragging operation is not taken as the dragging start event in the set area until the dragging operation enters within the set area. The dragging placement input box for receiving the dragging information is provided for the user when the client identifies the user's dragging start event in the set area.

In the embodiments of the disclosure, a dragging operation may be specific to a local file or may be specific to network resource. Different sources of data information of the dragging operation may cause different types of the data information corresponding to the dragging operation. Therefore, the extracting data information inputted by the user into the dragging placement input box includes:

identifying a type of data information corresponding to the user's dragging operation; and

when the type of the data information is determined to be a local file, providing address information for the user's local equipment for uploading an image, accessing the address, acquiring image information corresponding to the dragging operation, and taking the image information as the extracted data information inputted by the user into the dragging placement input box.

Some images are saved on the user's local equipment. These images may be downloaded from the Internet or may be obtained by the user by photographing. In the embodiments of the disclosure, an identification may be performed on the images saved on the user's local equipment. Specifically, the user may dragging the images saved on the user's local equipment into the dragging placement input box provided by the client. When the client identifies a dragging start event in the set area, the client provides address information for the user's local equipment for uploading an image according to the type of data information corresponding to the dragging operation, so that the user uploads the image to the address. After the user's local equipment uploads the image to the address, the client accesses the address to acquire image information corresponding to the dragging operation. In the process of uploading the image, to facilitate the user to timely know about the process of uploading the image, prompt information “Uploading the file” may be displayed in the dragging placement input box.

In the embodiments of the disclosure, the sending the request carrying the data information to the image engine server includes:

identifying a dragging end event triggered by the user into the dragging placement input box; and

sending the request carrying the data information to the image engine server.

Specifically, the identifying a dragging end event triggered by the user in the dragging placement input box includes:

when it is monitored an operation of releasing the left mouse button in the dragging placement input box, taking the operation as the dragging end event triggered by the user in the dragging placement input box.

According to the above description, in the embodiments of the disclosure, the dragging end event triggered by the user in the dragging placement input box is also monitored by means of a listening event. Specifically, the dragging end event is acquired by monitoring the user input module in the user's local equipment. Since at the moment the location of the client is known, the location of the dragging placement input box is also known. It is determined whether the dragging end event is identified or not by monitoring whether the user triggers an operation of releasing the left mouse button in the dragging placement input box or not.

It is determined that the dragging end event triggered by the user in the dragging placement input box is identified when it is identified the operation of releasing the left mouse button in the dragging placement input box. The extracted data information in the dragging placement input box is carried in a request, and the request is sent to the image engine server.

The image engine server receives the request, and acquires other image resource-related information matching with the image information according to the image information carried in the request and to established index information. Specifically, the image index server establishes a characteristic index database according to browsed images, and after receiving the screenshot information, the image index server extracts characteristics such as colors, shapes and textures of the images, matches the images with images in the characteristic index database according to a certain rule, and takes images succeeded in matching as an identification result to be provided for the client.

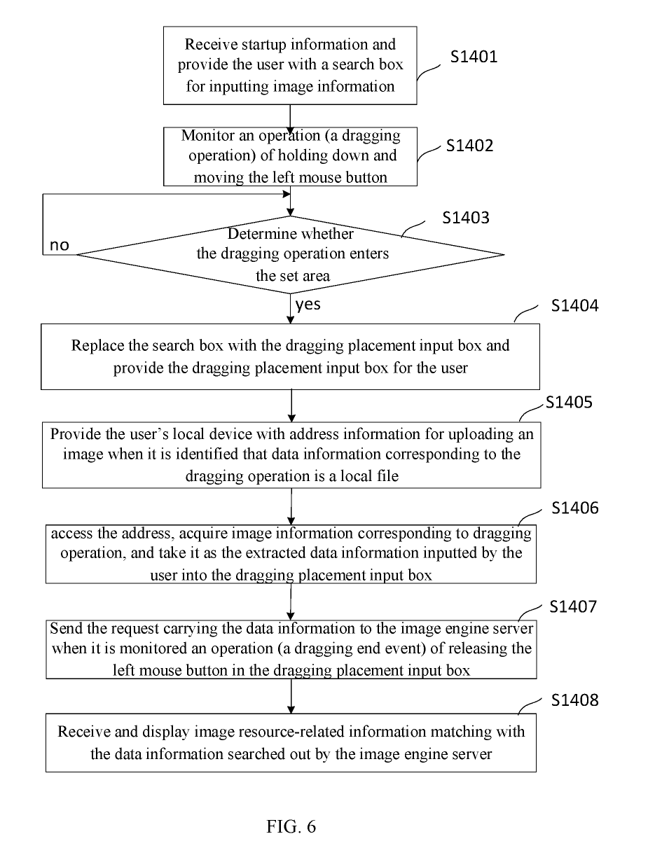

FIG. 6 is a process of identifying an image based on locally dragging an image according to an embodiment of the disclosure, where the process includes following steps:

S1401: Receive startup information and provide the user with a search box for inputting image information.

S1402: Monitor an operation (a dragging operation) of holding down and moving the left mouse button.

S1403: Determine whether the dragging operation enters the set area, go to Step S1404 when a determining result is that the dragging operation enters the set area, otherwise go to Step S1403.

S1404: Replace the search box with the dragging placement input box and provide the dragging placement input box for the user.

S1405: Provide the user's local equipment with address information for uploading an image when it is identified that data information corresponding to the dragging operation is a local file.

The local file specifically is an image file containing image information.

S1406: After the user's local equipment uploads the image to the address, access the address, acquire image information corresponding to the dragging operation, and take the image information as the extracted data information inputted by the user into the dragging placement input box.

S1407: Send the request carrying the data information to the image engine server when it is monitored an operation (a dragging end event) of releasing the left mouse button in the dragging placement input box.

S1408: Receive and display image resource-related information matching with the data information searched out by the image engine server.

The foregoing embodiment shows a process of identifying dragging an image from the user's local equipment and identifying the image. When the type of data information is determined to be network resource according to the type of the data information corresponding to the dragging operation, the extracting data information inputted by the user into the dragging placement input box includes: identifying the type of data information corresponding to the user's dragging operation; and when the type of the data information is determined to be network resource, acquiring a resource link address corresponding to the image information; and when the data information corresponding to the resource link address is determined to be image information, taking the resource link address as the extracted data information inputted by the user into the dragging placement input box.

When an image is dragged from the Internet, the data information corresponding to the dragging operation is a link address. Therefore, the source of the data information corresponding to the dragging operation may be determined according to the type of the data information. When the type of the data information is determined to be network resource, it is determined whether the data information corresponding to the resource link address is image information or not. When the data information corresponding to the resource link address is image information, the resource link address is taken as the extracted data information inputted by the user into the dragging placement input box.

When it is determined whether the data information corresponding to the resource link address is image information or not, the data information corresponding to the resource link address may be directly accessed to determine whether the format of the data information is the format of the image information so as to determine whether the data information is the image information or not. Alternatively, it is directly determined whether a suffix of the resource link address is a suffix of an image format, for example, it is determined whether the suffix of the resource link address is .jpg or .png or the like. It is determined that the data information corresponding to the resource link address is image information when the suffix of the resource link address is the suffix of an image format.

As shown in 7B, when network resource is dragged, for example, a link address of an image to be dragged is http://i2.3conline.com/images/piclib/201112/07/batch/1/119940/1323247381299u10eyma616.jpg, the client identifies the dragging start event in the set area, replaces the search box with the dragging placement input box, and displays prompt information “Dragging the image here” in the dragging placement input box. When the client determines that the type of the data information corresponding to the dragging operation is the resource link address after the data information is dragged into the dragging placement input box, it is determined that the data information is from network resource, it is acquired the resource link address corresponding to the image information, it is determined that the suffix of the resource link address is .jpg, it is determined that the data information corresponding to the resource link address is image information, and the resource link address is taken as the extracted data information inputted by the user into the dragging placement input box. When a dragging end event is identified in the dragging placement input box, a request carrying the resource link address is sent to the image engine server. The image engine server searches out and sends image resource-related information matching with the data information to the client, and the client displays an image identification result of the to-be-identified image constructed according to other image resource-related information. For example, in the image identification result, what is displayed in the search box is an image corresponding to the link address http://i2.3conline.com/images/piclib/201112/07/batch/1/119940/1323247381299u10eyma616.jpg, the search box also displays a description text “Plants vs. Zombies” matching with the image, and below the search box there displays other image resource-related information matching with the image information. For example, below the search box there displays other image resource-related information matching with data information in the search box, for example, a best guess at the data information, or an image related to the data information. Of course, to provide comprehensive information for the user, the image identification result may further include webpages containing the data information, etc.

In the embodiments of the disclosure, image resource-related information matching with data information corresponding to a dragging operation is provided for the user based on the user's dragging operation, thereby implementing the method for identifying an image based on image information, broadening an application scope of image identification, and facilitating use for the user.

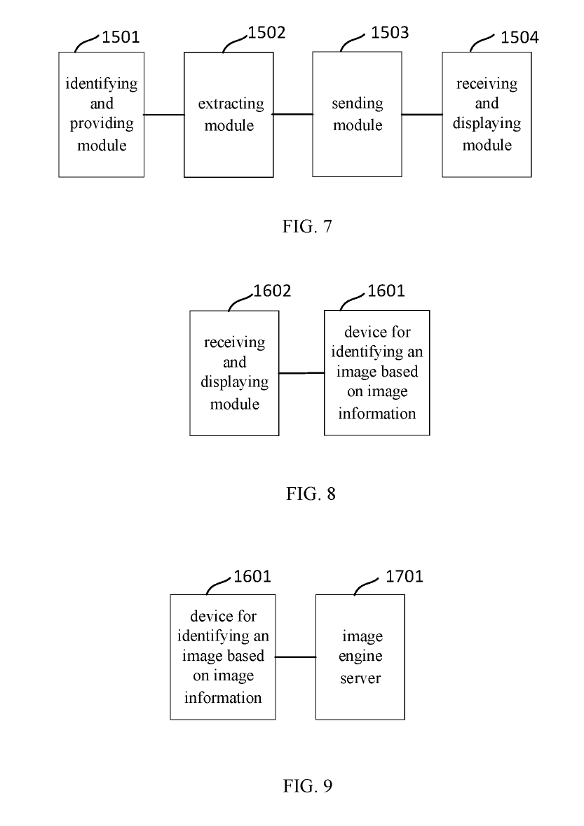

FIG. 7 is a schematic structural diagram of a device for identifying an image based on dragging an image according to an embodiment of the disclosure, where the device includes:

an identifying and providing module 1501, configured to identify a user's dragging operation in a set area, and provide a dragging placement input box for the user;

an extracting module 1502, configured to extract data information inputted by the user into the dragging placement input box;

a sending module 1503, configured to send a request carrying the data information to an image engine server; and

a receiving and displaying module 1504, configured to receive and display image resource-related information matching with the data information searched out by the image engine server.

The identifying and providing module 1501 is specifically configured to provide the user with a dragging placement input box for receiving dragging information when it is identified the user's dragging start event in a set area.

The identifying and providing module 1501 is specifically configured to take, when it is monitored an operation of holding down and moving a left mouse button in the set area, the operation as the user's dragging start event in the set area.

The extracting module 1502 is specifically configured to identify a type of data information corresponding to the user's dragging operation, provide address information for the user's local equipment for uploading an image when the type of the data information is determined to be a local file, access the address after the user's local equipment uploads the image to the address, acquire image information corresponding to the dragging operation, and take the image information as the extracted data information inputted by the user into the dragging placement input box.

The extracting module 1502 is specifically configured to identify the type of data information corresponding to the user's dragging operation, acquire a resource link address corresponding to the image information when the type of the data information is determined to be network resource, and take the resource link address as the extracted data information inputted by the user into the dragging placement input box when the data information corresponding to the resource link address is determined to be the image information.

The sending module 1503 is specifically configured to identify a dragging end event triggered by the user in the dragging placement input box, and send the request carrying the data information to the image engine server.

The sending module 1503 is specifically configured to take, when it is monitored an operation of releasing the left mouse button in the dragging placement input box, the operation as the dragging end event triggered by the user in the dragging placement input box.

The identifying and providing module 1501 is further configured to provide, before identifying the user's dragging operation in the set area, the user with a search box for inputting image information.

The identifying and providing module 1501 is specifically configured to replace, when it is identified the user's dragging operation in the set area, the search box with the dragging placement input box, and provide the dragging placement input box for the user.

FIG. 8 is a schematic structural diagram of terminal equipment according to an embodiment of the disclosure, where the terminal equipment includes the device 1601 mentioned in FIG. 7.

The terminal equipment further includes:

a user input module 1602, configured to record information of operation of a mouse and a location where the operation occurs; and

the device 1601, specifically configured to take, when a location where an operation of holding down and moving a left mouse button occurs is monitored to be within the set area, the operation as the user's dragging start event in the set area.

The device 1601 is further configured to take, when it is monitored that the operation of releasing the left mouse button occurs in the dragging placement input box, the operation as the dragging end event triggered by the user in the dragging placement input box.

FIG. 9 is a schematic structural diagram of a system for identifying an image based on dragging an image according to an embodiment of the disclosure, where the system includes the above device 1601, and an image engine server 1701 configured to receive a request carrying the data information, search out and provide other image resource-related information matching with the data information.

Embodiments of the disclosure provide a method, system, equipment and device for identifying an image based on dragging an image. The method includes: identifying a user's dragging operation in a set area, and providing a dragging placement input box; extracting data information inputted by the user into the dragging placement input box, and sending the data information to an image engine server; and receiving and displaying image resource-related information matching with the data information returned by the image engine server. In the embodiments of the disclosure, image resource-related information matching with data information corresponding to a dragging operation is provided for the user based on the user's dragging operation, thereby implementing the method for identifying an image based on image information, broadening an application scope of image identification, and facilitating use for the user.

To implement a scheme for identifying an image based on image information, broaden an application scope of image identification and facilitate use for a user, the embodiments of the disclosure provide a method, system, equipment and device for identifying an image based on screenshot information.

In the following the embodiments of the disclosure are described with reference to the accompanying drawings.

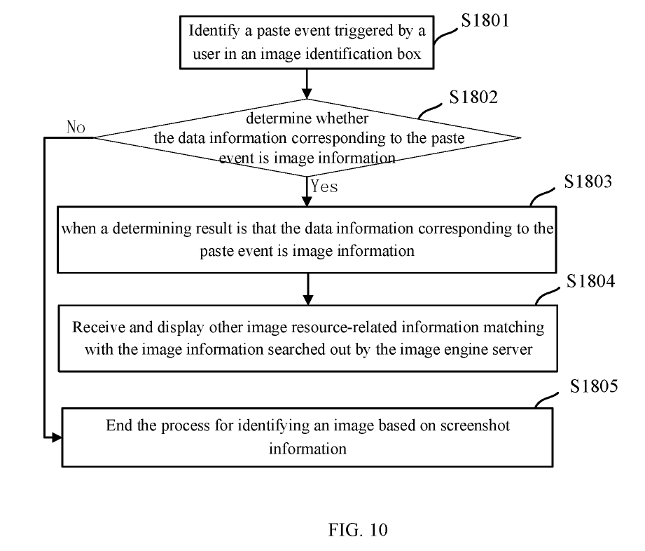

FIG. 10 is a schematic diagram showing a process of identifying an image based on screenshot information according to an embodiment of the disclosure, where the process includes following steps:

S1801: Identify a paste event triggered by a user in an image identification box.

In the embodiments of the disclosure, when a client for identifying an image based on screenshot information is turned on, the client provides the user with an image identification box for inputting image information.

The identifying a paste event triggered by a user in an image identification box specifically includes identifying a “Ctrl+V” operation triggered in the image identification box, or identifying a “Copy” operation triggered in the image identification box, etc.

S1802: Acquire data information corresponding to the paste event, and determine whether the data information corresponding to the paste event is image information or not, go to Step S1803 when a determining result is that the data information corresponding to the paste event is image information, otherwise go to Step S1805.

S1803: Send a request carrying the image information to an image engine server.

After it is received the request carrying the image information sent by the user, the request is sent to the image engine server, and other image resource-related information matching with screenshot information is provided for the user by means of the image engine server.

S1804: Receive and display other image resource-related information matching with the image information searched out by the image engine server.

It is received other image resource-related information matching with the data information searched out by the image engine server, and an image identification result is constructed according to the other image resource-related information.

S1805: End the process for identifying an image based on screenshot information.

In the embodiments of the disclosure, image resource-related information matching with the screenshot information is provided for the user based on the copied screenshot information, thereby implementing the method for identifying an image based on image information, broadening an application scope of image identification, and facilitating use for the user.

In the embodiments of the disclosure, when a client is turned on, the client provides the user with an image identification box for inputting screenshot information.

To identify the user's operation in the image identification box, in the embodiments of the disclosure, a listening event is bound in the client, where in the listening event, information on operation of a mouse and a keyboard and location where the operation occurs are listened. Specifically, information such as whether each button of the mouse is pressed, which buttons of the keyboard are pressed and pressed at what time and at what location or the like is recorded in a user input module of an operating system of the user's local equipment. A left mouse button being pressed and a right mouse button being pressed respectively correspond to a binary number. The listening event determines whether the current right mouse button is pressed or not by listening a corresponding binary number in the user input module of the operating system of the user's local equipment. When the location where the operation of the right mouse button being pressed occurs is positioned in the image identification box, a menu available for selection is provided for the user. When it is identified that the user selects a paste operation, it is determined that the user triggering a paste event in the image identification box is identified.

In addition, an operation of each button in the keyboard being pressed and the location where the operation occurs are recorded in the user input module of the operating system of the user's local equipment. It is determined that the user triggering a paste event in the image identification box is identified when the listening event listens an operation of both Ctrl key and V key on the keyboard being simultaneously pressed and the location where the operation occurs is positioned in the image identification box.

When it is identified the paste event triggered by the user in the image identification box, the acquiring data information corresponding to the paste event includes:

accessing a clipboard of the user's local equipment according to the paste event; and

acquiring the data information corresponding to the paste event in the clipboard.

Before the user triggers the paste event in the image identification box, a screenshot operation is performed on a locally-saved image or an image on the Internet, and screenshot information corresponding to the screenshot operation is saved in the clipboard of the user's local equipment. When it is identified the paste event triggered by the user in the image identification box, it is accessed the clipboard of the user's local equipment, and it is acquired the data information corresponding to the paste event in the clipboard.

After the client acquires the data information corresponding to the paste event in the clipboard, it is determined whether the data information is image information. Specifically, it is determined whether a format of the data information corresponding to the paste event meets the format of the image information. For example, it is determined whether the format of the data information is an image format such as a .Jpg format or a .png format, etc. The data information is determined to be the image information when the format of the data information is an image format.

The process of acquiring screenshot information from the user's local equipment is similar to that of uploading screenshot information. Based on network connection status between the client and the user's local equipment, to facilitate the user to timely know about the process of uploading screenshot information, prompt information “Uploading the file” is displayed, and a prompt box where the prompt information is may substitute or overlay the image identification box.

After acquiring the image information corresponding to the paste event, the client sends the request carrying the image information, converts the image information to a base64 format, and sends the request in which the converted image information is carried to the image engine server.

The image engine server receives the request, and acquires other image resource-related information matching with the image information according to the image information carried in the request and to established index information. Specifically, the image index server establishes a characteristic index database according to browsed images, and after receiving the image information, the image index server extracts characteristics such as colors, shapes and textures of the images, matches the images with images in the characteristic index database according to a certain rule, and takes images succeeded in matching as an identification result to be provided for the client.

When the client receives a paste event triggered in the image identification box, the client accesses the clipboard of the user's local equipment to acquire image information in the clipboard, and displays the acquired image information, for example an image of an apple, in the image identification box. After acquiring the image information from the clipboard of the user's local equipment, the client sends a request carrying the image information to the image engine server. The image engine server acquires, according to the image information carried in the request, other image resource-related information matching with the image information, and provides the image resource-related information to the client for display. According to an image identification result constructed according to the image information, the client not only displays the image of an apple in the image identification box of the image identification result, but also displays and processes the word “apple” matching with the image. Under the image identification box there is displayed other image resource-related information matching with the image information—the image of an apple, for example, a best guess at the image information and apple-related images. Of course, to provide comprehensive information for the user, the image identification result may further include webpages “Recognize Objects Cards 1 in Shanghainese: General View-Winterspring Shanghainese Series (iPad) cracked . . . ” containing the image information, etc.

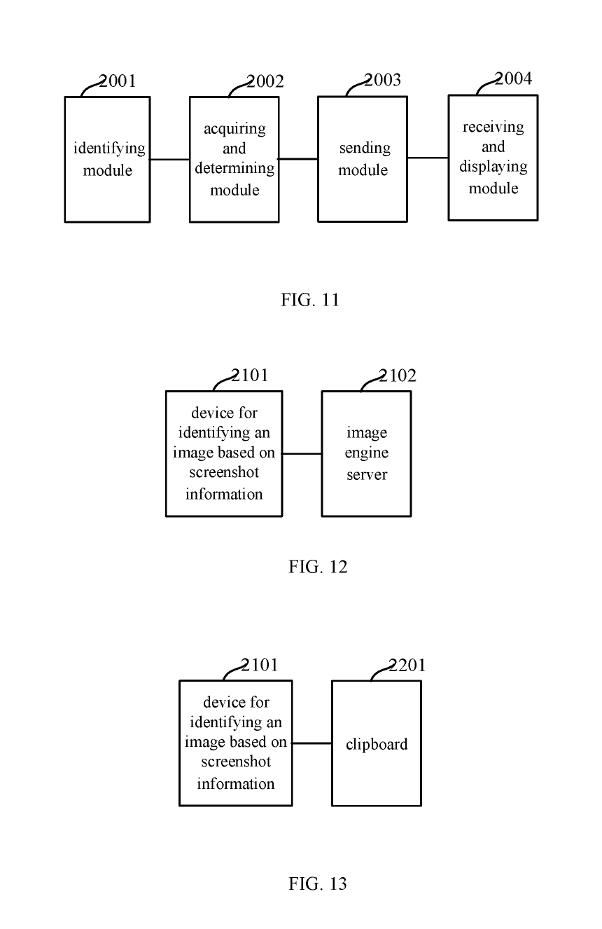

FIG. 11 is a schematic structural diagram of a device for identifying an image based on screenshot information according to an embodiment of the disclosure, where the device includes:

an identifying module 2001, configured to identify a paste event triggered by a user in an image identification box;

an acquiring and determining module 2002, configured to acquire data information corresponding to the paste event, and determine whether the data information corresponding to the paste event is image information or not;

a sending module 2003, configured to send a request carrying the image information to an image engine server when the data information corresponding to the paste event is determined by the acquiring and determining module to be image information; and

a receiving and displaying module 2004, configured to receive and display other image resource-related information matching with the image information searched out by the image engine server.

The acquiring and determining module 2002 is specifically configured to access a clipboard of the user's local equipment according to the paste event, and acquire the data information corresponding to the paste event in the clipboard.

The acquiring and determining module 2002 is specifically configured to determine whether a format of data information corresponding to the paste event meets the format of the image information or not.

The sending module 2003 is specifically configured to convert the data information to a base64 format, and send the request in which the converted data information is carried to the image engine server.

FIG. 12 is a schematic structural diagram of a system for identifying an image based on screenshot information according to an embodiment of the disclosure, where the system includes the device 2101 as shown in FIG. 11 and an image engine server 2102 configured to search out other image resource-related information matching with the image information according to the request and send the other image resource-related information to the device.

FIG. 13 is a schematic structural diagram of terminal equipment according to an embodiment of the disclosure, where the terminal equipment includes the device 2101 as shown in FIG. 11.

The terminal equipment further includes:

a clipboard 2201, configured to save data information corresponding to a copy event; and

the device 2101, specifically configured to access the clipboard according to the paste event, and acquire the data information corresponding to the paste event in the clipboard.

Embodiments of the disclosure provide a method, system, equipment and device for identifying an image based on screenshot information. The method includes: identifying a paste event triggered by a user in an image identification box; when data information corresponding to the paste event is determined to be image information, sending a request carrying the image information corresponding to the paste event to an image engine server; and receiving and displaying other image resource-related information matching with the image information searched out by the image engine server. In the embodiments of the disclosure, image resource-related information matching with the screenshot information is provided for the user based on the copied screenshot information, thereby implementing the method for identifying an image based on image information, broadening an application scope of image identification, and facilitating use for the user.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the components in the client, server or system according to the embodiments of the disclosure. The disclosure may further be implemented as equipment program (for example, computer program and computer program product) for executing some or all of the methods as described herein. Such program for implementing the disclosure may be stored in the computer readable medium, or have a form of one or more signals. Such a signal may be downloaded from the Internet websites, or be provided in carrier, or be provided in other manners.

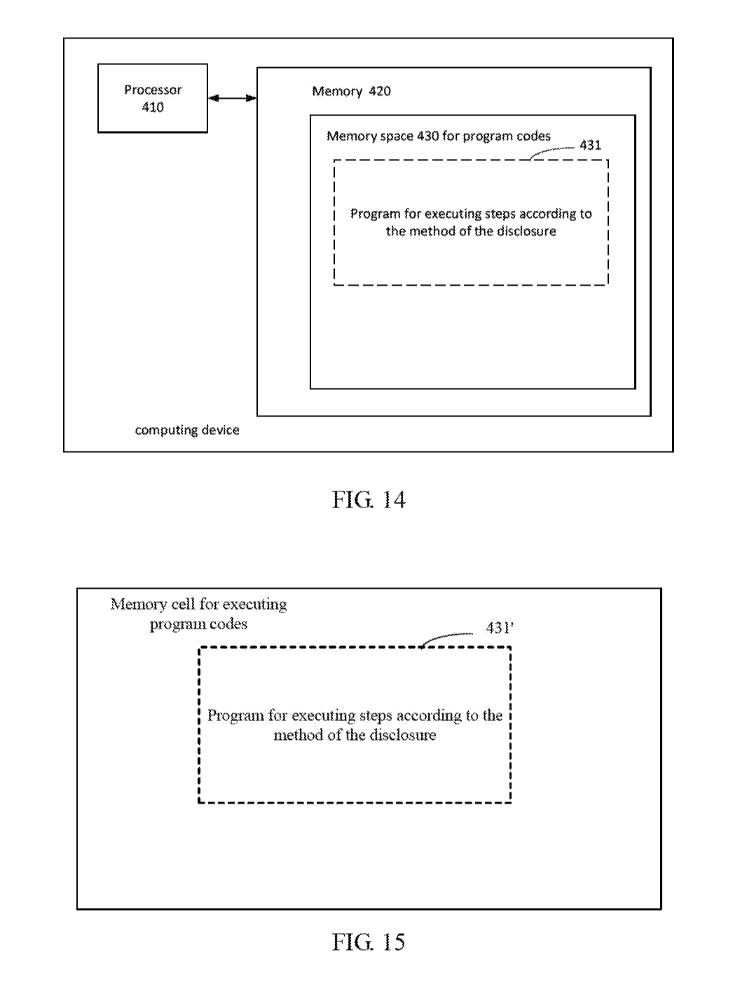

For example, FIG. 14 schematically shows a block diagram of a computing device for executing the method according to the disclosure; Traditionally, the computing device includes a processor 410 and a computer program product or a computer readable medium in the form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 15. The memory cells may be provided with memory sections, memory spaces, etc., similar to the memory 420 of the computing device as shown in FIG. 14. The program codes may be compressed for example in an appropriate form. Usually, the memory cell includes a program 431′ for executing the methodic steps according to the disclosure, which could be codes readable for example by a processor 410. When these codes are operated on the computing device, the computing device may execute respective steps in the method as described above.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

1. A method for identifying an image based on image information, comprising:
extracting to-be-identified image information inputted by a user into an image identification box;
sending a request carrying the to-be-identified image information to an image engine server;
receiving other image resource-related information matching with the to-be-identified image information searched out by the image engine server; and
displaying an image identification result of the to-be-identified image constructed according to the other image resource-related information.

2. The method of claim 1, wherein the extracting to-be-identified image information inputted by a user into an image identification box comprises:
identifying a paste event triggered by the user in a search box;
accessing a clipboard of user's local equipment according to the paste event; and
acquiring data information data information corresponding to the paste event in the clipboard, and determining whether the data information corresponding to the paste event is image information;
sending a request carrying the image information to an image engine server when the data information corresponding to the paste event is image information.

3. The method of claim 1, wherein before the extracting to-be-identified image information inputted by a user into an image identification box, the method further comprises:
providing the user with a dragging placement input box for receiving dragging information during identifying the user's dragging start event in a set area.

4. The method of claim 3, wherein the identifying the user's dragging start event in a set area comprises:
during monitoring an operation of holding down and moving a left mouse button in the set area, taking the operation as the user's dragging start event in the set area.

5. The method of claim 4, wherein the sending a request carrying the to-be-identified image information to an image engine server comprises:
identifying a dragging end event triggered by the user in the dragging placement input box; and
sending the request carrying the to-be-identified image information inputted into the dragging placement input box to the image engine server.

6. The method of claim 5, wherein the identifying a dragging end event triggered by the user in the dragging placement input box comprises:
during monitoring an operation of releasing the left mouse button in the dragging placement input box, taking the operation as the dragging end event triggered by the user in the dragging placement input box.

7. The method of claim 3, wherein the extracting to-be-identified image information inputted by a user into an image identification box comprises:
identifying a type of to-be-identified image information corresponding to the user's dragging operation; and
when the to-be-identified image information is determined to be a local file, providing address information for the user's local equipment for uploading an image; and after the user's local equipment uploads the image to the address, accessing the address, acquiring image information corresponding to the dragging operation, and taking the image information as the extracted to-be-identified image information inputted by the user into the dragging placement input box.

8. The method of claim 3, wherein the extracting to-be-identified image information inputted by a user into an image identification box comprises:
identifying a type of to-be-identified image information corresponding to the user's dragging operation; and
when the to-be-identified image information is determined to be network resource, acquiring a resource link address corresponding to the image information; and when data information corresponding to the resource link address is determined to be the image information, taking the resource link address as extracted to-be-identified image link address information inputted by the user into the dragging placement input box.

9.-22. (canceled)

23. A computing device for identifying an image based on image information, comprising:
a memory having instructions stored thereon;
a processor configured to execute the instructions to perform operations for identifying an image based on image information, comprising:
extracting to-be-identified image information inputted by a user into an image identification box;
sending a request carrying the to-be-identified image information to an image engine server; and
receiving other image resource-related information matching with the to-be-identified image information searched out by the image engine server, and displaying an image identification result of the to-be-identified image constructed according to the other image resource-related information.

24.-32. (canceled)

33. A computer-readable medium, having computer programs stored thereon that, when executed by one or more processors of a computing device, cause the computing device to perform:
extracting to-be-identified image information inputted by a user into an image identification box;
sending a request carrying the to-be-identified image information to an image engine server;
receiving other image resource-related information matching with the to-be-identified image information searched out by the image engine server; and
displaying an image identification result of the to-be-identified image constructed according to the other image resource-related information.

34. The method of claim 2, wherein sending a request carrying the image information to an image engine server when the data information corresponding to the paste event is image information comprises:
when the data information corresponding to the paste event is screenshot information, taking the screenshot information as the extracted to-be-identified image information inputted by the user into the search box.

35. The method of claim 3, wherein before providing the user with a dragging placement input box for receiving dragging information during identifying the user's dragging start event in a set area, the method further comprises:
providing the user with a search box for inputting image information.

36. The method of claim 35, wherein the providing the user with a search box for inputting image information comprises:
when the user's dragging operation in the set area is identified, replacing the search box with the dragging placement input box and providing the dragging placement input box for the user.

37. The computing device of claim 23, wherein the extracting to-be-identified image information inputted by a user into an image identification box comprises:
identifying a paste event triggered by the user in a search box;
accessing a clipboard of user's local equipment according to the paste event; and
acquiring data information corresponding to the paste event in the clipboard, and determining whether the data information corresponding to the paste event is image information;
sending a request carrying the image information to an image engine server when the data information corresponding to the paste event is image information.

38. The computing device of claim 23, wherein the processor is further configured to perform:
providing the user with a dragging placement input box for receiving dragging information during identifying the user's dragging start event in a set area.

39. The computing device of claim 38, wherein the identifying the user's dragging start event in a set area comprises:
during monitoring an operation of holding down and moving a left mouse button in the set area, taking the operation as the user's dragging start event in the set area.

40. The computing device of claim 39, wherein the sending a request carrying the to-be-identified image information to an image engine server comprises:
identifying a dragging end event triggered by the user in the dragging placement input box; and
sending the request carrying the to-be-identified image information inputted into the dragging placement input box to the image engine server.

41. The computing device of claim 40, wherein the identifying a dragging end event triggered by the user in the dragging placement input box comprises:
during monitoring an operation of releasing the left mouse button in the dragging placement input box, taking the operation as the dragging end event triggered by the user in the dragging placement input box.

42. The computing device of claim 37, wherein sending a request carrying the image information to an image engine server when the data information corresponding to the paste event is image information comprises:
when the data information corresponding to the paste event is screenshot information, taking the screenshot information as the extracted to-be-identified image information inputted by the user into the search box.

43. The computing device of claim 38, wherein before providing the user with a dragging placement input box for receiving dragging information during identifying the user's dragging start event in a set area, the method further comprises:
providing the user with a search box for inputting image information.
the providing the user with a search box for inputting image information comprises:
when the user's dragging operation in the set area is identified, replacing the search box with the dragging placement input box and providing the dragging placement input box for the user.
